(19) United States
(12) Patent Application Publication
(10) Pub. No.: US 2013/0143642 A1
(43) Pub. Date: Jun. 6, 2013

(54) SIDE BET FOR PAI-GOW

(71) Applicant: Geoff Hall, Solihull (GB)

(72) Inventor: Geoff Hall, Solihull (GB)

(21) Appl. No.: 13/662,543

(22) Filed: Oct. 29, 2012

Related U.S. Application Data
(60) Provisional application No. 61/553,167, filed on Oct. 29, 2011.

(51) Int. Cl. G07F 17/32; A63F 1/00

(52) U.S. Cl. CPC G07F 17/32; A63F 1/00
USPC 463/22; 273/292

(57) ABSTRACT

A method, apparatus, and non-transitory computer readable storage medium to implement a Pai-Gow side bet which uses an embedded electronic display in a Pai-Gow table to pick a random number from one to seven. Each player makes an optional side bet and if the player's hand qualifies, the player's side bet wins a payout which is determined by multiplying a value of the player's hand by the random number. If the player's hand does not qualify, then the player's side bet loses.

### CROSS REFERENCE TO RELATED APPLICATIONS

This application claims benefit to U.S. provisional application 61/553,167 filed on Oct. 29, 2011, entitled, “SIDE BET FOR PAI-GOW” which is incorporated by reference herein in its entirety.

### BACKGROUND OF THE INVENTION

1. Field of the Invention

The present general inventive concept is directed to a method, apparatus, and computer readable storage medium directed to a side bet that can be added to a Pai-Gow game.

2. Description of the Related Art

The casino game of Pai-Gow is well known, for example see U.S. Patent publication 2006/0244218, which is incorporated by reference herein in its entirety for all purposes.

### SUMMARY OF THE INVENTION

It is an aspect of the present invention to provide a side bet for Pai-Gow.

The above aspects can be obtained by a method that comprises (a) receiving a main wager and a side wager from a player using a Pai-Gow table; (b) dealing a player's set of cards to a player and a dealer's set of cards to a dealer; (c) activating a random number generator to generate a random number; (c) determining if the player's set of cards qualifies for a payout; (d) resolving the side wager according to a set of predetermined rules, wherein if the player's set of cards does not qualify then the player loses the side wager, and if the player's set of cards qualify then paying a payout to the player on the side wager, the payout being determining by multiplying the random number by a value of the player's set of cards; and (e) completing the Pai-Gow game and resolving the main wager based on an outcome of the Pai-Gow game.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing a side bet for a Pai-Gow game, according to an embodiment;

FIG. 2 is a drawing of an exemplary table layout, according to an embodiment;

FIG. 3 is a block diagram illustrating hardware that can be used for the embedded display 201; and

FIG. 4 is a block diagram illustrating hardware that can be used to implement electronic versions of the wagering methods described herein, according to an embodiment.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a pai-gow side bet.

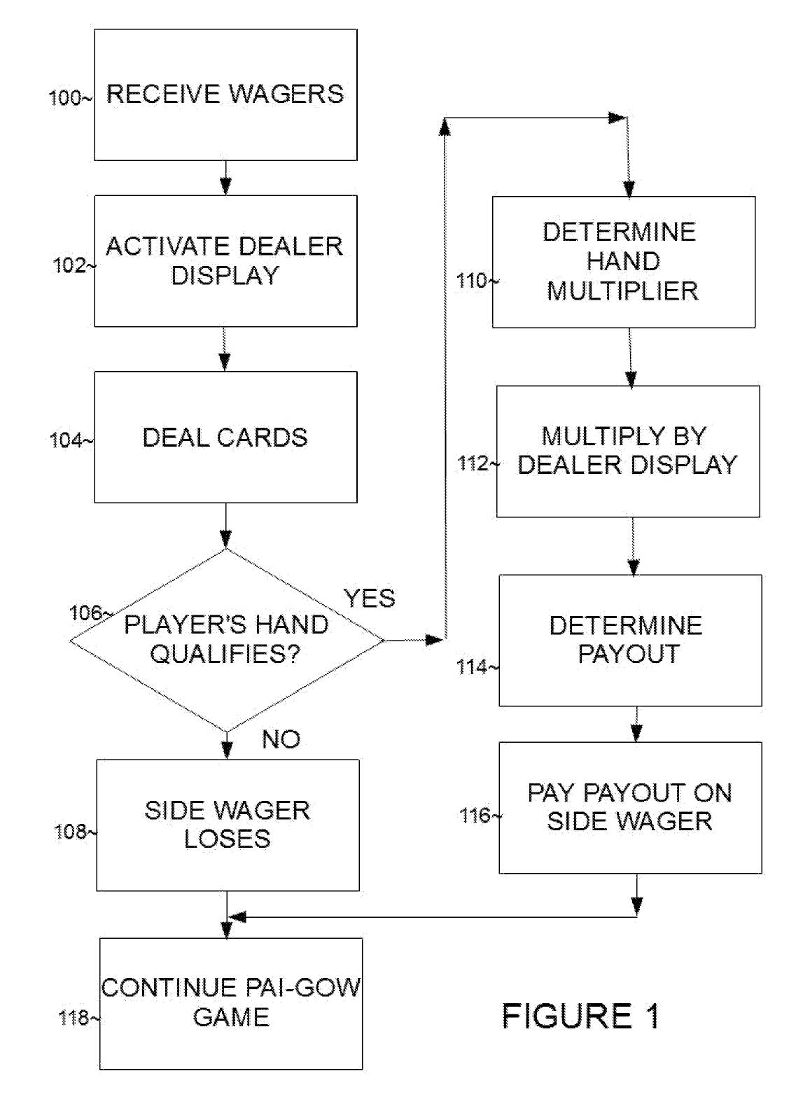

FIG. 1 is a flowchart illustrating a method of implementing a side bet for a Pai-Gow game, according to an embodiment.

The method can begin with operation 100, which receives wagers from players at the table. Each player typically places a main wager on an outcome of the Pai-Gow game and an optional side wager.

From operation 100, the method proceeds to operation 102, wherein the dealer activates the dealer display. On a Pai-Gow table, an electronic LED display can be present which can randomly select a number from 1 to 7 (the randomly selected number lights up on a LED display). The rightmost (from the dealer) player at the table is player number 1, the next player is player number 2, etc. (typically there would be 7 players at a table). This number (automatically randomly selected) then determines which player is dealt first (the remaining players are then dealt in counter-clockwise (or clockwise) direction). As an alternative to using an electronic LED display, dice can be used to determine who to deal to first. For example, three dice can be rolled and summed together, and starting with the rightmost player, the total rolled can be counted down (circling around the table if necessary) to determine which player is dealt to first. After the determined player is dealt first, the players (and dealer) are dealt in clockwise (or counterclockwise) order.

From operation 102, the method proceeds to operation 104, wherein the dealer deals cards. This comprises dealing each player at the table and the dealer seven cards each.

From operation 104, the method proceeds to operation 106, which determines whether the player's cards qualify for a payout on the side bet. If the player's cards do not meet qualifying conditions then the method proceeds to operation 108 and the side wager loses (which is then taken by the dealer). From operation 108, the method proceeds to operation 118, wherein the Pai-Gow game is continued.

The qualifying conditions can be, for example, if the player's seven cards have a poker ranking of at least a pair of queens, kings, or aces (in other words at least a pair of queens). Other qualifying conditions can be, for example, at least any pair, at least any three of a kind, at least an ace high, or any other poker ranking

If the player's cards qualify (meet a minimum ranking to earn a payout on the side bet), then the method proceeds to operation 110 which determines a hand multiplier. A hand multiplier is a multiplier that is determined based on all seven of the player's cards. A table such as that in Table I can be used to determine the hand multiplier (only the highest ranking in the cards is used). Note that if the player's cards do not form (contain) at least a pair of A's (aces), Q's (queens), or K's (kings), then the player does not qualify and the player loses the side bet.

TABLE I

| Hand | Multiplier |
|---|---|
| Pair A's, Q's, or K's | 1 |
| 3 A's, Q's, K's | 5 |
| 4 A's, Q's, K's | 50 |
| All others | 0 |

Of course, Table I is merely one example of multipliers. In one embodiment, only the poker ranks shown in a table being used can be used to qualify for the side bet (for example, in Table I, if the player has a straight it would not qualify the player). Table II below is another example of multiplier table. In another embodiment, all standard poker ranks can be used, such as straights, flushes, etc., and as long as the player achieves a minimum rank (e.g., pair of J's-A's) or a poker rank that ranks higher than the minimum rank (according to standard poker rankings), then the player would qualify. Thus, in this embodiment, if the player had a flush then according to Table II the player would qualify, since a flush (according to standard poker rankings) ranks higher than a pair of A's, Q's, K's, or J's. The house is of course free to choose the set of cards dealt to the player that qualifies and also each particular hand's respective multiplier.

TABLE II

| Hand | Multiplier |
|---|---|
| Pair A's, Q's, K's or J's | 1 |
| 3 2's-10's | 5 |
| 3 J's, Q's, or K's | 7 |
| 3 A's | 10 |
| 5 card straight | 12 |
| 4 2's-K's | 50 |
| 4 A's | 100 |
| All red cards | 25 |
| None of the above | 0 |

Once the hand multiplier is known (using the cards in the cards dealt to the player), the method proceeds to operation 112

In operation 112, the multiplier determined in operation 110 is multiplied by the number shown on the activated dealer display (from operation 102). As an alternative to using the dealer display (some Pai-Gow tables do not have this electronic display), other mechanisms can be used to produce another random number such as a roll of dice, spin of a wheel, etc. Instead of the electronic dealer display to determine which player to deal first, other mechanisms can be used to randomly pick the first player, such as rolling dice, etc. The total of dice rolled (instead of using an electronic dealer display) can also be multiplied by the multiplier from operation 110. In one embodiment, all qualifying hands have a positive (non-zero) multiplier and thus the side bet wins (the random number generator only determines the payout).

In another embodiment, some qualifying hands may only win on certain numbers generated by the random number generator; for example, if the player has a hand of five black cards then this has a multiplier of 0 for generated random numbers from 1-3 and has a multiplier of 1 for generated random numbers higher than 3 (in other words, this particular hand only pays if the random number generator is higher than 3). The range of the random number generator can typically be from 1-7 (if the display shows 0-6 then one can be added to the display), although in another embodiment the random number generator can include 0 (thus even if the player has a qualifying hand the side bet has a payout of 0 and hence loses (or pushes)). Any range of random numbers can of course be used (e.g., 1-10, etc.)

From operation 112, the method proceeds to operation 114, which determines the payout on the player's side wager (placed in operation 100). This is determined by taking the number computed in operation 112 and multiplying this by the side wager amount (from operation 100) to determine the final payout amount (the amount the player has won on the side bet). Thus, in other words, the side bet is paid at a payout equal to the hand multiplier multiplied by the dealer display (or other random number generator output).

From operation 114, the method proceeds to operation 116, which pays to the player the payout amount computed in operation 114. From operation 116, the method proceeds to operation 118, which continues the Pai-Gow game as known in the art (e.g., the player and dealer sets their hand, then the main wager is resolved).

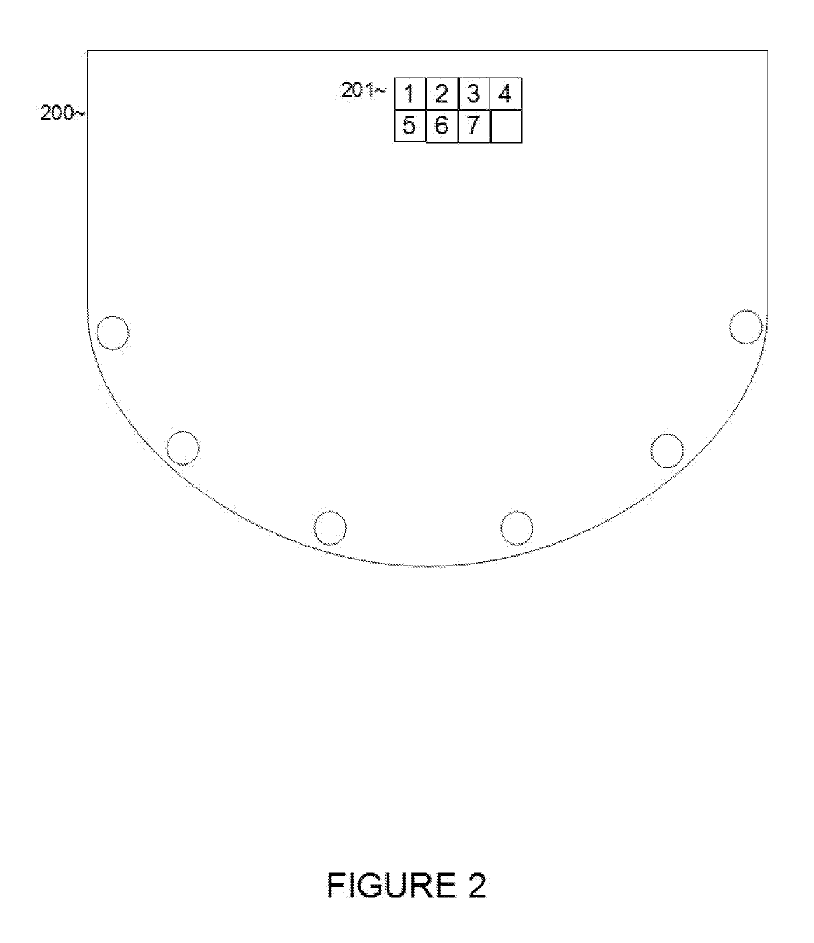

FIG. 2 is a drawing of an exemplary table layout, according to an embodiment.

A physical gaming table 200 is a standard gaming table with a felt on top and a plurality of betting circles for the players (this table accommodates six players). The table 200 also has an embedded display 201 which is used to randomly pick the first player to deal to. When a button (not pictured) is pressed, one out of the seven numbers is randomly chosen to light up (players are numbered 1 through 6 from right to left, and the dealer is number 7) while the other numbers not randomly chosen are not lit up so that all people at the table (players and dealer) can see which random number was automatically selected by the processing unit (not pictured in FIG. 2) of the electronic random number generator. Thus, the embedded display 201 would display the electronically chosen random number from operation 102.

As an alternative to the embedded display 201, other mechanisms can be used to select a random number from 1 through 7. For example a seven sided die, a wheel with seven places, three six-sided dice (after dividing by 7, using the remainder as the random number with the dealer being in position ‘0’), or any other such mechanism.

In a further embodiment, the hand multiplier (as described herein) can be based on getting a single card multiple times. For example, Table III below illustrates an example of getting a single card type (aces).

TABLE III

| Hand | Multiplier |
|---|---|
| 4 A's | 100 |
| 3 A's | 50 |
| 2 A's | 25 |
| 1 A | 2 |
| All others | 0 |

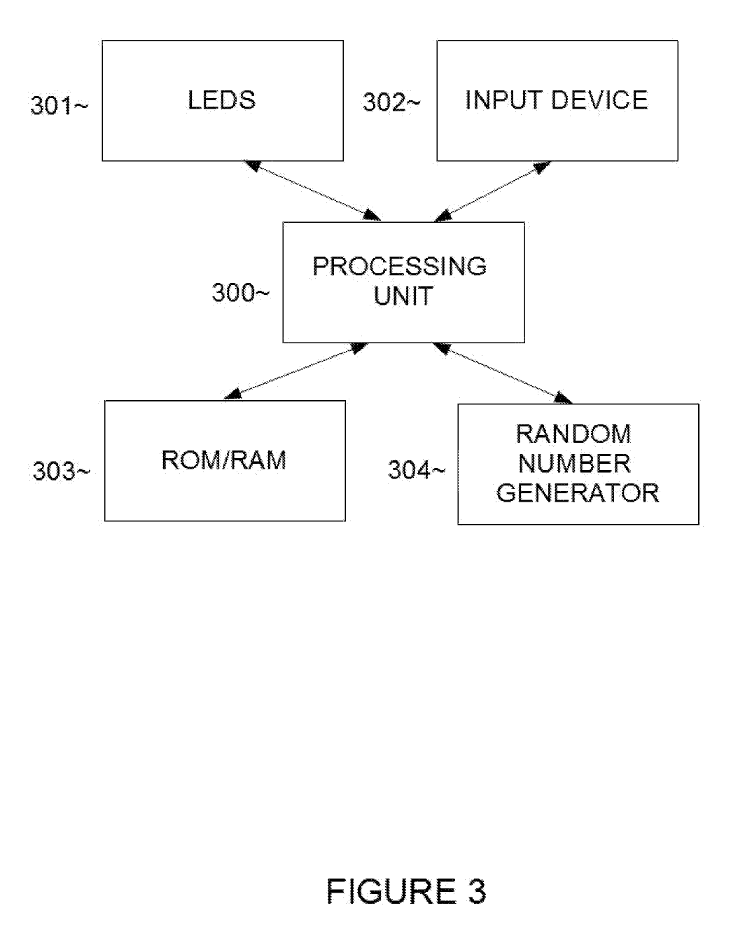

FIG. 3 is a block diagram illustrating hardware that can be used for the embedded display 201. The hardware illustrated in FIG. 3 can be physically embedded into the physical gaming table 200.

An electronic processing unit 300 can be an electronic microprocessor (and associated structures) executes instructions which perform the operation of determining and displaying the random number, is connected to the LEDs 301 (which are the individual numbers which can be addressed individually and light on/off (shown as display 201 in FIG. 2 so only the random number selected by the processing unit 300 is lit up), or can alternatively be a 7-segment display, LCD, or other electronic output device which can display the random number selected by the electronic processing unit 300. The processing unit 300 can also be connected to an input device 302, which can be a button which instructs the processing unit to initiate the sequence to pick a new random number. The sequence (which can be coded in ROM 303 and executed on the processing unit 300) activates a random number generator 304 to pick a random number from 1 to 7 (which can be stored in RAM 303) which the processing unit then addresses the respective LED in the LEDS 301 to turn on (light up). The ROM/RAM 303 stores temporary memory (RAM) needed for the display and also any fixed code (ROM) needed to execute the sequence. Not pictured is a power button which provides/cuts off a power supply to the system.

An example of the game will now be presented, using Table I. Wendy places a $1 main wager and a $1 side wager. Wendy is dealt: King-spades/King-hearts/King-diamonds/3-clubs/4-spades/8-hearts/10-diamonds. Wendy qualifies by having at least a pair of queens, kings or aces (a pair of kings). In fact, Wendy has three kings thereby giving Wendy's hand (cards) a value of 5 according to Table I. The dealer activates the random number generator which results in a number of 4. Thus, the payout on Wendy's $1 side wager is 5 multiplied by 4 equals 20 (20:1), thus Wendy wins a $20 payout (and can keep the original $1 wager). The Pai-Gow game now continues as known in the art in order to resolve Wendy's $1 main wager.

Another example will now be presented. Wendy places a $1 main wager and a $1 side wager. Wendy is dealt: 7-spades/8-spades/9-spades/10-spades/Jack-spades/3-hearts/ace-diamonds. Wendy does not qualify because Wendy's hand is not one of the hands in Table I, thereby Wendy loses her $1 side wager and the game continues in order to resolve Wendy's $1 main wager. Even though Wendy has a five card straight flush, this is not one of the hands in Table I, thus this hand does not qualify.

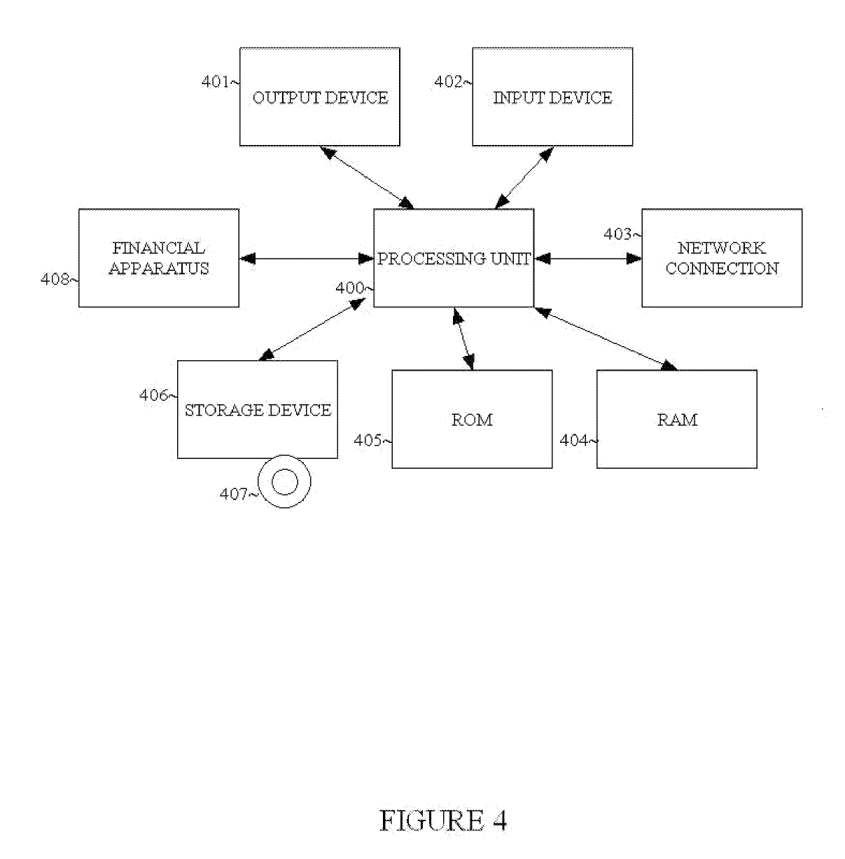

FIG. 4 is a block diagram illustrating hardware that can be used to implement electronic versions of the wagering methods described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety.

A processing unit 400 (such as a microprocessor and any associated components) is connected to an output device 401 (such as an LCD monitor, touch screen, CRT, etc.) and an input device 402 (e.g., buttons, a touch screen, a keyboard, mouse, etc.) All methods described herein can be performed by the processing unit 400 by loading and executing respective instructions. The processing unit 400 can also be connected to a network connection 403, which can connect the electronic gaming device to a computer communications network such as the Internet, a LAN, WAN, etc. The processing unit 400 is also connected to a RAM 404 and a ROM 405. The processing unit 400 is also connected to a storage device 406 which can be a DVD-drive, CD-ROM, flash memory, etc. A non-transitory computer readable storage medium 407 (such as a compact disc, DVD-ROM, hard disk, etc.) can store a program which can control the electronic device to perform any of the methods described herein. The processing unit 400 can also be connected to a financial apparatus 408 which can receive cash and convert the received cash into playable credits for use by the player when playing the electronic device. When the player decides to cash out any remaining credits, the financial apparatus 408 can issue coins or a cashless ticket (voucher) for the remaining credits which is redeemable by the player.

It is noted that the methods described herein can be played with any number of standard decks of 52 cards (e.g., 1 deck to 10 decks). A standard deck has four sets of suits (diamonds, clubs, hearts, spades) and each set has 13 cards (2, 3, 4, 5, 6, 7, 8, 9, 10, jack, queen, king, ace). Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a non-transitory computer readable storage to control a computer. An electronic processing unit can be configured (programmed) to perform all of the methods described herein. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a Pai-Gow game, the method comprising:
providing at least one physical deck of cards;
receiving a main wager and a side wager from a player using a Pai-Gow table;
dealing, from the at least one physical deck of cards, a player's set of cards to a player and a dealer's set of cards to a dealer;
activating a random number generator to generate a random number;
determining if the player's set of cards qualifies for a payout;
resolving the side wager according to a set of predetermined rules, wherein if the player's set of cards does not qualify then the player loses the side wager, and if the player's set of cards qualify then paying a payout to the player on the side wager, the payout being determining by multiplying the random number by a value of the player's set of cards; and
completing the Pai-Gow game and resolving the main wager based on an outcome of the Pai-Gow game.

2. The method as recited in claim 1, wherein the random number is an electronic random number generator which comprises an electronic display embedded in the Pai-Gow table.

3. The method as recited in claim 1, wherein the random number generator is dice.

4. The method as recited in claim 1, wherein the value of the player's set of cards is determined by a table of hand and respective values.

5. The method as recited in claim 1, wherein the random number generator comprises:
an electronic output device; and
an electronic processing unit configured to determine a random number and display the random number on the electronic output device.

6. The method as recited in claim 5, wherein the electronic output device comprises a plurality of individually addressable numbered lights for each possible random number.

7. The method as recited in claim 1, wherein a first player that is dealt first is identified based on the random number.

8. A method for implementing a Pai-Gow game, the method comprising:
executing the following instructions on an electronic processing unit to perform:
receiving a main wager and a side wager from a player using a Pai-Gow table;
dealing a player's set of cards to a player and a dealer's set of cards to a dealer;
activating a random number generator to generate a random number;
determining if the player's set of cards qualifies for a payout;
resolving the side wager according to a set of predetermined rules, wherein if the player's set of cards does not qualify then the player loses the side wager, and if the player's set of cards qualify then paying a payout to the player on the side wager, the payout being determining by multiplying the random number by a value of the player's set of cards; and
completing the Pai-Gow game and resolving the main wager based on an outcome of the Pai-Gow game.

9. The method as recited in claim 8, wherein the value of the player's set of cards is determined by a table of hand and respective values.

10. An apparatus to implement a Pai-Gow game, the apparatus comprising:
an electronic output device;
an electronic input device;
an electronic processing unit connected to the electronic output device and the electronic input device, the electronic processing unit configured to:
receive a main wager and a side wager from a player using a Pai-Gow table;
deal a player's set of cards to a player and a dealer's set of cards to a dealer;
activate a random number generator to generate a random number;
determine if the player's set of cards qualifies for a payout;
resolve the side wager according to a set of predetermined rules, wherein if the player's set of cards does not qualify then the player loses the side wager, and if the player's set of cards qualify then paying a payout to the player on the side wager, the payout being determining by multiplying the random number by a value of the player's set of cards; and
complete the Pai-Gow game and resolving the main wager based on an outcome of the Pai-Gow game.

11. The apparatus as recited in claim 10, wherein the value of the player's set of cards is determined by a table of hand and respective values.
